(19) United States
(12) Patent Application Publication
(10) Pub. No.: US 2006/0062014 A1
(43) Pub. Date: Mar. 23, 2006

(54) LCD light source projection construction

(75) Inventors: Wen-Pao Tseng, Yangmei Taoyuan (TW); Hsin-Chien Chiang, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-Bridge Electronics Co., Ltd.

(21) Appl. No.: 10/945,866

(22) Filed: Sep. 22, 2004

(51) Int. Cl. F21V 11/00; F21V 7/04

(52) U.S. Cl. 362/558

(57) ABSTRACT

An LCD light source projection construction having light emitters evenly distributed in a cavity; the cavity being integrated with a light permeable layer to be adhered with optical film; multiple dimmers being disposed on and integrated with the light permeable layer to create reflection and deflection for the light beams passing through so to consistently present light source from each light emitter to omit the installation of a diffuser, simplify LCD configuration and effectively reduce LCD thickness.

### BACKGROUND OF THE INVENTION

(a) Field of the Invention

The present invention is related to an improved construction of light source projection in an LCD, and more particularly to one simplifies LCD configuration and effectively reduce the thickness of the LCD.

(b) Description of the Prior Art:

FIG. 1 shows a schematic view of a basic configuration of an LCD generally available in the market and a light source projection configuration of the prior art. Wherein, the LCD has multiple light emitters 20 evenly distributed in a reflector mask 10; an optical film 30 comprised of a lower diffuser, a prism, and a polarizer (or the upper diffuser) disposed in sequence at an opening provided on the reflector mask 10; and a liquid crystal panel 40 to present the performance effects of light sources from those light emitters 20.

The reflector mask 10 is essentially used to project all the light sources form those light emitters 20 in the direction leading to the liquid crystal panel 40 so to maintain consistent luminance on each part of the liquid crystal panel 40. However, in practice, the location of the light emitter 20 is closer to the liquid crystal panel 40 than the reflector mask 10 is resulting in that most of the light source form each light emitter 20 directly project toward the direction of the liquid crystal panel 40 to produce bright stripes thereon at where in relation to the location of each light emitter 20 is provided.

As a result, a diffuser 50 is sandwiched between the reflector mask 10 and the optical film 30 to facilitate the light beams passing through the diffuser 50 are diffused first before being projected in the direction leading to the liquid crystal panel 40 to eliminate those bright stripes created by each light emitter 20. However, the addition of the diffuser 50 complicates the constituent members of the LCD as a whole and thickens the LCD to frustrate the appeals for making a compact LCD.

### SUMMARY OF THE INVENTION

The primary purpose of the present invention is to provide an improved construction for the light source projection of an LCD that omits the installation of a diffuser, simplifies the configuration of the LCD and effectively makes the LCD thinner. To achieve the purpose, the LCD gives the light source performance effects through an optical film and a liquid crystal panel in terms of the basic configuration of the LCD; wherein, multiple light emitters are evenly distributed in a cavity; the cavity is integrated with a light permeable layer to be adhered with the related optical film; multiple dimmers are integrated with light permeable layer to deflect and reflect light beams passing through it to consistently present the light source from the light emitter.

### BRIEF DESCRIPTION OF THE DRAWINGS

FIG. 1 is a schematic view showing a light source projection configuration of the prior art in an LCD.

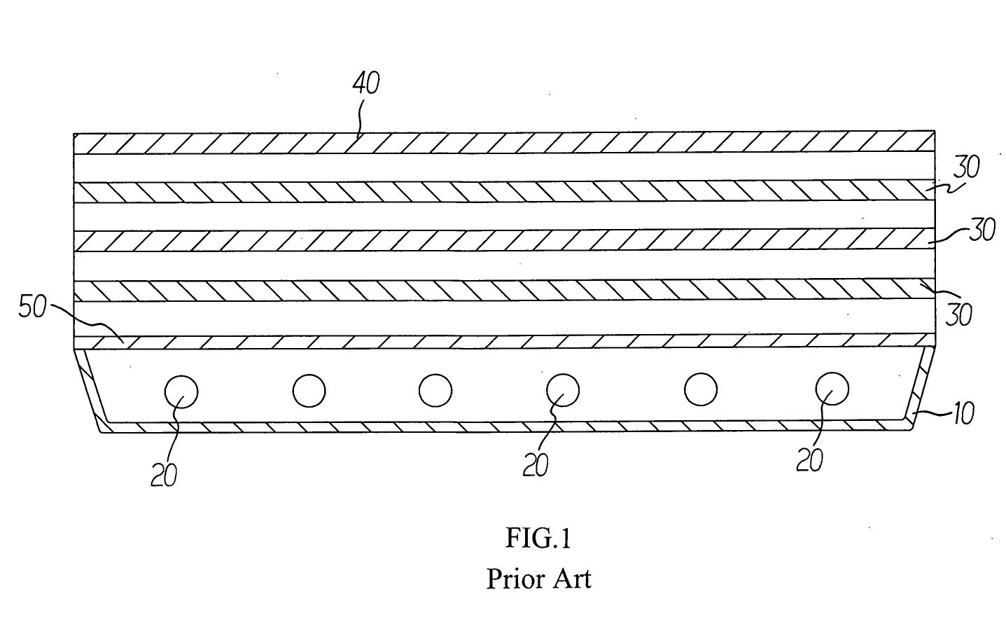

FIG. 2 is a schematic view showing a light source projection configuration of the present invention.

FIG. 3 is a schematic view showing a dimmer of a first preferred embodiment of the present invention.

FIG. 4 is a magnified view of a dimmer construction of a second preferred embodiment of the present invention.

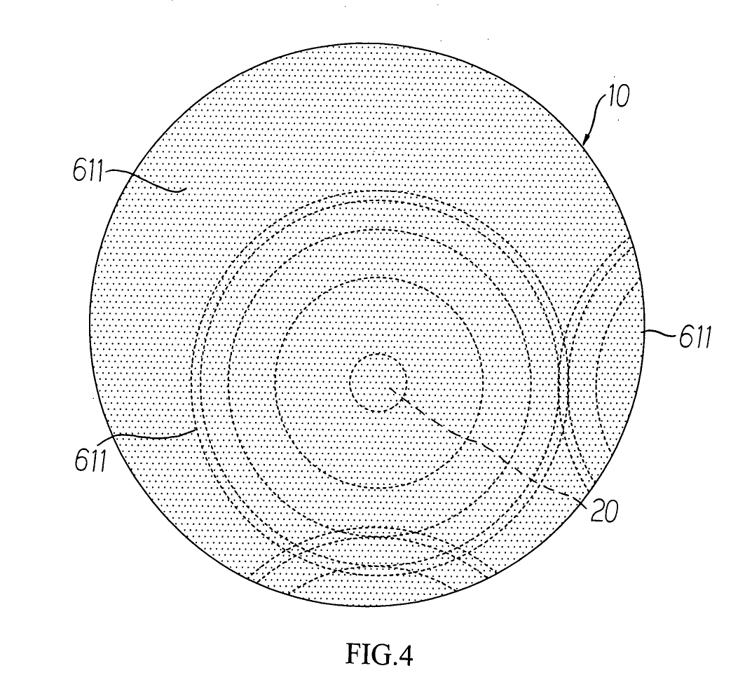

FIG. 5 is schematic view showing the dimmer construction of the second preferred embodiment of the presence invention.

FIG. 6 is schematic view showing a dimmer construction of a third preferred embodiment of the presence invention.

FIG. 7 is schematic view showing the installation of a dimmer of a fourth second preferred embodiment of the presence invention.

FIG. 8 is schematic view showing the installation of a dimmer of the fifth preferred embodiment of the presence invention.

### DETAILED DESCRIPTION OF THE PREFERRED EMBODIMENTS

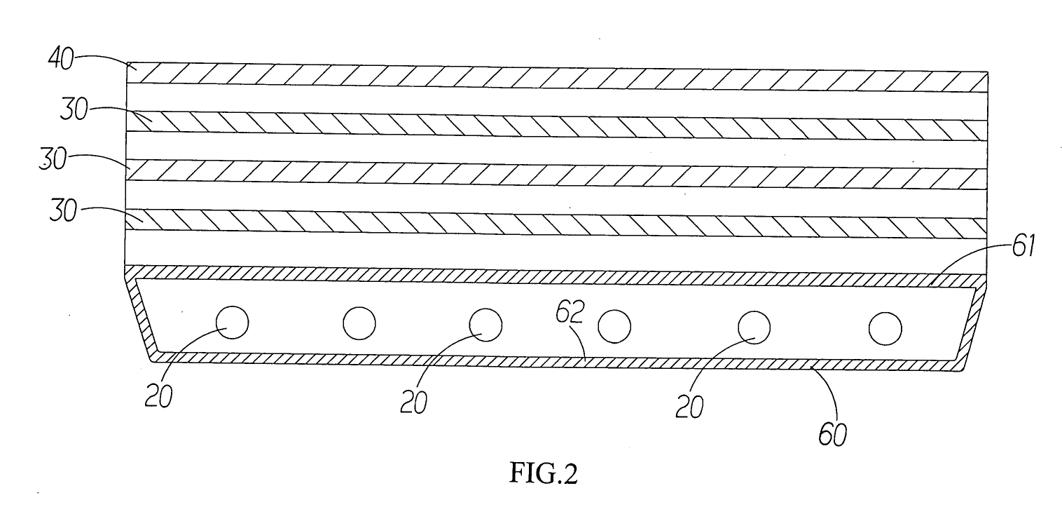

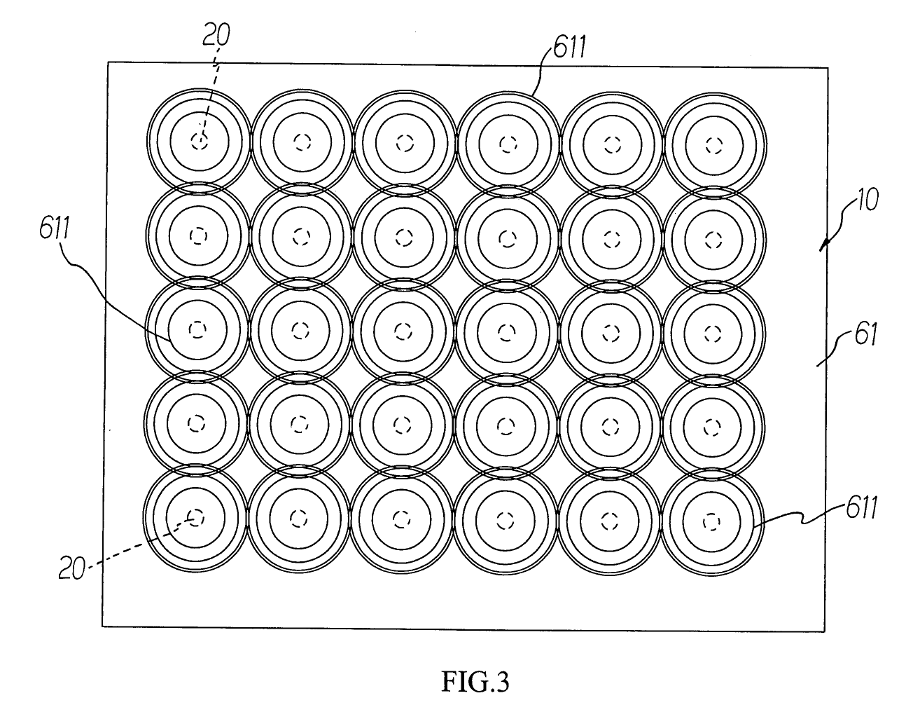

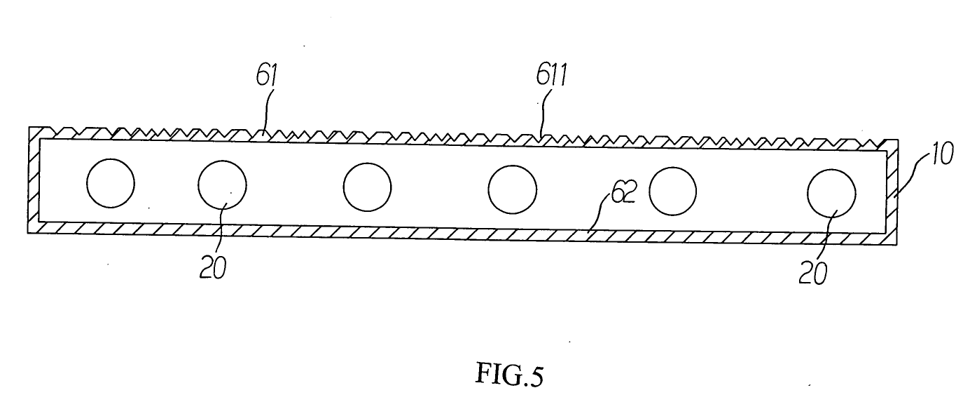

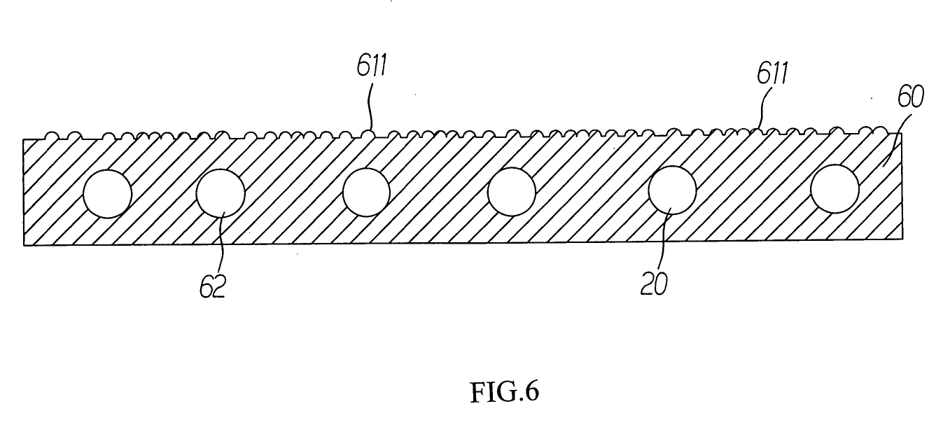

The basic configuration of a LCD in a LCD light source projection construction of the present invention as illustrated in FIG. 2 includes an optical film 30 comprised of a lower diffuser, a prism, a polarizer (or a upper diffuser), and a liquid crystal panel 40 to present performance effects of light sources from multiple light emitters 20.

Wherein, those light emitters 20 are evenly distributed in a cavity 60 made of transparent material and integrated with a light permeable layer 61 to be adhered with the optical film 30. The light permeable layer 61 is integrated with multiple dimmers 611. As illustrated in FIGS. 3 and 5, those dimmers 611 are made in a form of arc channels (e.g., in V or U shape as illustrated in FIG. 5), or arc ribs (in U or V shape as illustrated in FIG. 6) on the surface of the light permeable layer 61; or comprised of multiple concave and convex points by means of laser, casting, cutting, sandblasting, printing, etching, or meshed so to deflect and reflect the light beams passing through the light permeable layer 61, thus to consistently present the light source from each light emitter 20.

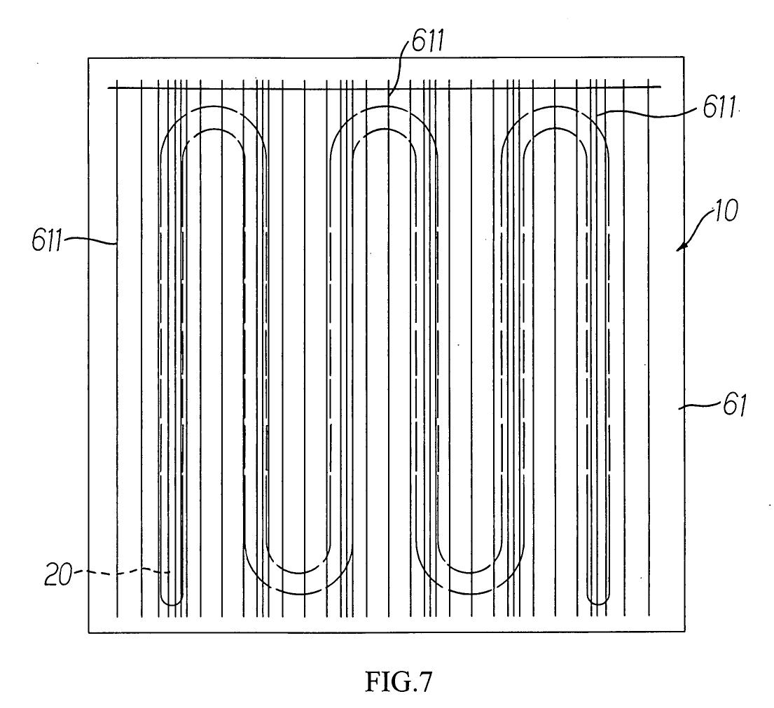

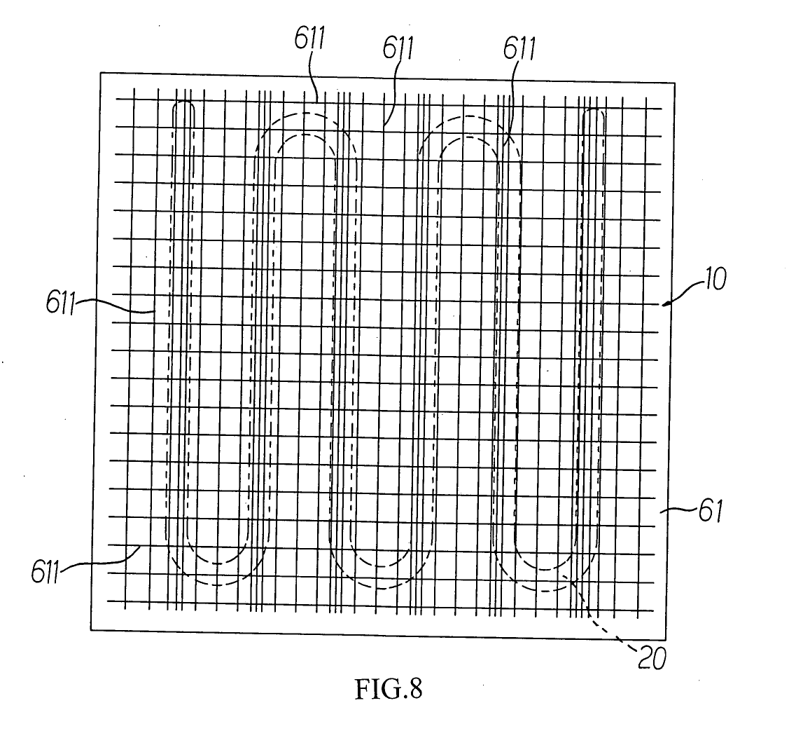

Those light emitters may be distributed in a pattern of continuous curves in the cavity 60 as illustrated in FIGS. 6 and 8. Accordingly, those dimmers 611 are arranged on those linear channels or ribs formed on the surface of the light permeable layer 60 to achieve the same light dimming results. Those dimmers 611 may be arranged at a continuously or non-continuously fixed spacing with the spacing subject to readjustment depending on the arrangement density of those light emitters 20. Those dimmers 611 may be arranged vertically so to deliver the consistent light results by evenly distribution of those light sources as illustrated in FIG. 7. As those light emitters 20 are more collectively arranged, the general luminance of those light sources among light emitters 20 is comparatively higher to justify the comparatively sparse arrangement of those dimmers 611. Alternatively, the denser and non-transparent of dimmers are printed at the section where provided with higher luminance of light sources to eliminate certain light beams giving way to the evenly distributed light sources for reducing the difference between brighter are and darker area. When those light emitters 20 are arranged at a greater spacing as illustrated in FIG. 8, dimmers 611 located farther from the light emitter 20 are arranged more intensively, or non-transparent dimmers are printed over light emitters to further effectively allocate light beams from those light sources.

Furthermore, as illustrated in FIG. 6, light permeable material is distributed in the cavity integrated with multiple dimmers. Therefore, the bright stripes created by each light emitter 20 can be effectively eliminated weather those light emitters 20 are arranged in dot, straight rod or even in the fashion featuring continuous curves.

The present invention by omitting the installation of any diffuser, simplifying the configuration of the LCD; effectively reducing the thickness of the LCD; and complying with compact design appeals of the LCD provides an improved LCD projection construction. Therefore, this application for a utility patent is duly filed. However it is to be noted that the preferred embodiments disclosed in the specification and the accompanying drawings are not limiting the present invention. Therefore, any construction, installation, or characteristics that is same or similar to that of the present invention should fall within the scope of the purposes and claims of the present invention.

I claim:

1. An LCD light source projection construction has multiple light emitters evenly distributed in a cavity; the cavity being integrated with a light permeable layer; multiple dimmers being integrated with the light permeable layer; light beams passing through the light permeable layer being deflected and reflected to consistently present light source from each light emitter.

2. The LCD light source projection construction of claim 1, wherein, those dimmers are comprised of linear channels or ribs formed on the surface of the light permeable layer.

3. The LCD light source projection construction of claim 1, wherein, those dimmers are comprised of arc channels or ribs on the surface of the light permeable layer.

4. The LCD light source projection construction of claim 2, wherein, those channels or ribs are made each in U or V shape.

5. The LCD light source projection construction of claim 3, wherein, those arc channels or ribs are made each in U or V shape.

6. The LCD light source projection construction of claim 1, wherein, those dimmers are comprised of multiple concave and convex points formed on the surface of the light permeable layer.

7. The LCD light source projection construction of claim 6, wherein, those concave and convex points are formed by means of laser, casting, cutting, sandblasting, printing, etching or meshed.

8. The LCD light source projection construction of claim 1, wherein, spacing among multiple dimmers can be in continuously fashion or not.

9. The LCD light source projection construction of claim 1, wherein, the cavity is made of light permeable material and a reflector is provided on the bottom of the cavity.
